(19) United States
(12) Patent Application Publication
(10) Pub. No.: US 2014/0254400 A1
(43) Pub. Date: Sep. 11, 2014

(54) METHODS AND APPARATUSES FOR PROVIDING A BINARY CHANNEL QUALITY INDICATOR FOR A SERVING WIRELESS CHANNEL

(71) Applicant: QUALCOMM Incorporated, San Diego, CA (US)

(72) Inventors: Yan ZHOU, San Diego, CA (US); George CHERIAN, San Diego, CA (US); Hemanth SAMPATH, San Diego, CA (US)

(73) Assignee: QUALCOMM Incorporated, San Diego, CA (US)

(21) Appl. No.: 13/788,477

(22) Filed: Mar. 7, 2013

(51) Int. Cl. H04L 1/00; H04L 12/26

(52) U.S. Cl. CPC H04L 1/0026; H04L 43/08
USPC 370/252

(57) ABSTRACT

The present disclosure presents methods and apparatuses for providing a simplified channel quality indicator associated with a serving channel to a serving wireless node, so that the load and delay for feedback can be minimized. For example, the present disclosure describes example methods of channel quality indicator determination and reporting by a user equipment (UE), which may include measuring a serving channel of a wireless node and calculating a binary channel quality indicator that identifies a general quality of a serving channel of the wireless node. Additionally, example methods may include transmitting the binary channel quality indicator from the UE to the wireless node. Furthermore, upon successful receipt of the binary channel quality indicator, the wireless node may alter one or more channel characteristics based on the binary channel quality indicator, thereby providing improved user experience at the UE.

### BACKGROUND

1. Field

Aspects of the present disclosure relate generally to wireless communication systems, and more particularly, to methods and apparatuses for improved channel quality indication.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (WCDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. As the demand for mobile broadband access continues to increase, research and development continue to advance the UMTS technologies not only to meet the growing demand for mobile broadband access, but to advance and enhance the user experience with mobile communications.

For example, in the current Wi-Fi standard, a wireless node (e.g. a serving wireless node or access point (AP)) can request a mobile station, such as a user equipment (UE) or other mobile device, to periodically send one or more measurement reports to the wireless node. This measurement report may contain data associated with various channel quality metrics, such as, but not limited to, retry rate, packet error rate (PER), access delay, retransmission or acknowledgement message (RTS/ACK) error rate, etc. However, the overhead caused by the measurement reporting and/or a wireless node requesting such measurement reporting is non-trivial due to the large metric numbers and large value ranges associated with each measurement report.

Therefore, methods and apparatuses are needed for generating a simplified channel quality indicator associated with a serving channel.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents methods and apparatuses for simplified and otherwise improved channel quality indication feedback to one or more wireless nodes in a wireless communication system. For example, the present disclosure describes example methods that may include measuring a serving channel of a serving wireless node, calculating a binary channel quality indicator that identifies a general quality of the serving channel, and transmitting the binary channel quality indicator to the serving wireless node.

In an additional aspect, the present disclosure presents example apparatuses, which may include means for measuring a serving channel of a serving wireless node, means for calculating a binary channel quality indicator that identifies a general quality of the serving channel, and means for transmitting the binary channel quality indicator to the serving wireless node. Moreover, the present disclosure presents example computer-readable media that may include machine-executable code for measuring a serving channel of a serving wireless node, calculating a binary channel quality indicator that identifies a general quality of the serving channel, and transmitting the binary channel quality indicator to the serving wireless node.

Furthermore, the present disclosure presents example apparatuses that may include at least one processor and a memory coupled to the at least one processor, where the at least one processor is configured to measure a serving channel of a serving wireless node, calculate a binary channel quality indicator that identifies a general quality of the serving channel, and transmit the binary channel quality indicator to the serving wireless node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example wireless system of aspects of the present disclosure;

FIG. 2 is a block diagram illustrating a detailed example of a user equipment and its components in an example wireless communications system according to aspects of the present disclosure;

FIG. 3 is a block diagram illustrating example components of a computer device according to the present disclosure;

FIG. 4 is a flow diagram illustrating aspects of a method for simplified calculation and transmission of a binary channel quality indicator according to aspects of the present disclosure;

FIG. 5 is a flow diagram illustrating additional or alternative aspects of a method for simplified calculation and transmission of a binary channel quality indicator according to aspects of the present disclosure;

FIG. 6 is a component diagram illustrating aspects of a logical grouping of electrical components as contemplated by the present disclosure;

FIG. 6 is a block diagram illustrating an example of a hardware implementation for an apparatus employing a processing system;

FIG. 8 is a block diagram conceptually illustrating an example of a telecommunications system;

FIG. 9 is a conceptual diagram illustrating an example of an access network;

FIG. 10 is a conceptual diagram illustrating an example of a radio protocol architecture for the user and control plane; and

FIG. 11 is a block diagram conceptually illustrating an example of a NodeB in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure teaches methods and apparatuses for providing a simplified and improved binary channel quality indicator (CQI) to a wireless node that limits the signaling overhead associated with traditional channel characteristic reporting in wireless systems. Basically, the STA will set the binary CQI if one or multiple measured metrics across corresponding thresholds, which can be configured by the AP. For example, STA can set the binary CQI to “poor quality” if any metric mentioned above exceeds corresponding threshold. Therefore, the load, delay, and battery consumption due to reporting/requesting can be reduced.

For example, the present disclosure presents examples wherein such a binary CQI can be as simple as a “good/poor” indicator. For instance, in one non-limiting example, a UE may set a binary CQI based on one or more conditions or events. In one such aspect, such a condition or event may include a UE determining that a parameter value associated with a serving channel is above or below (or equal to) a corresponding threshold.

In an optional alternative or additional aspect, the UE may set such a binary CQI if a weighted sum of a set of parameter values associated with one or more channels or UEs is above or below (or equal to) a corresponding threshold. Furthermore, in an aspect, one or more of the parameter values may be normalized to a percentage based on a particular range of parameter values. Additionally in some aspects, the parameters can be determined by the UE upon connection setup or reconfigured during connection and may include metric types involved in binary CQI computation, various thresholds or weights, and/or combinational logic, though these are non-limiting parameter examples. In a further aspect, these parameters (e.g. metric values) may be configured by a UE.

In a further aspect of the present disclosure, each of one or more UEs served by a serving wireless node may transmit a computed CPI to the serving wireless node. For example, in one non-limiting aspect, a UE may periodically transmit a binary CQI to a wireless node in one or more dedicated packets and/or as additional data piggybacking existing or scheduled data packets. Furthermore, in an additional or alternative aspect, the transmitted binary CQI may be located in a frame or packet body or may be included in a modified PHY/MAC header associated with a packet.

Additionally, the occurrence of one or more events may trigger the UE reporting the binary CQI to the serving wireless node. In an aspect, these one or more events may include, but are not limited to, the UE measuring that the received signal strength (e.g., RSSI) has reached or dropped below a corresponding threshold, a determination by the UE that the binary CQI indicates that the serving channel is “poor quality,” and/or the UE receiving a request from the wireless node to report the binary CQI. Based on the reported binary CQI, the serving cell may adjust operating characteristics of one or more UEs. For example, in an aspect, where a wireless node finds a relatively small number or percentage of UEs served by the wireless node indicating a binary CQI of “poor quality,” it may redirect these UEs to other wireless nodes or wireless systems for improved wireless service. Additionally or alternatively, where a wireless node determines that a large number or percentage of UEs served by the wireless node indicating a binary CQI of “poor quality,” the wireless node may switch its serving channel, for example, to a frequency having better communication characteristics, metrics, or parameters.

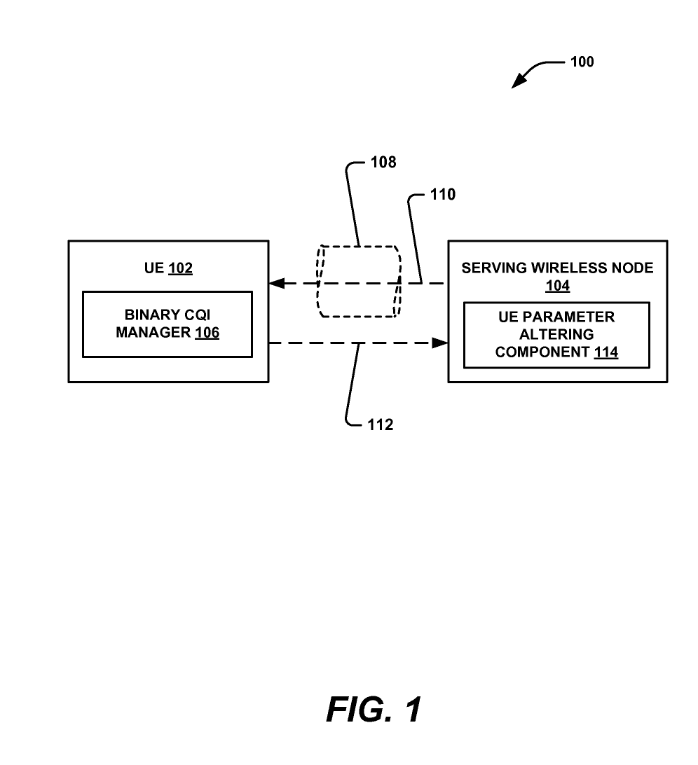

Referring to FIG. 1, a wireless communication system 100 that is configured to facilitate calculation and utilization of an improved channel CQI is illustrated. System 100 includes at least one UE 102 that may communicate wirelessly with one or more wireless nodes, including, but not limited to, serving wireless node 104 via serving channel. Wireless node 104 may be configured to transmit one or more signals 110 to UE 102 over the serving channel 108. In an aspect signal 110 may include one or more data signals over a data channel, but may also include one or more beacon signals. Additionally, serving channel 108 may inherently include one or more parameters that may be measured by UE 102, including, but not limited to, a signal-to-noise ratio (e.g., Ec/Io), Received Signal Code Power (RSCP), Received Signal Strength Indicator (RSSI), packet error rate (PER), average access delay, packet retransmission rate, Request-to-send, Clear-to-send, and/or Acknowledgement message (RTS/CTS/ACK) error rate, throughput, interference/load statistic, average physical layer data rate and/or any other parameter, such as, but not limited to, those parameters that may indicate channel throughput, quality, and/or reliability.

UE 102 may comprise a mobile apparatus and may be referred to as such throughout the present disclosure. Such a mobile apparatus or UE may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a further aspect, UE 102 may include a binary CQI manager, which may be configured to measure one or more parameters of serving channel 108 and calculate and report a binary CQI associated with the serving channel 108 based on these one or more parameters. This binary CQI may be transmitted from UE 102 to serving wireless node 104 via a message 112, which may be a dedicated data message or a scheduled data message that includes the binary CQI in a header or “piggybacked” envelope or other appended data.

Additionally, the one or more wireless nodes, including, but not limited to, serving wireless node 104 of system 100 may include one or more of any type of network component, such as an access point, including a base station (BS) or node B, a relay, a peer-to-peer device, an authentication, authorization and accounting (AAA) server, a mobile switching center (MSC), a radio network controller (RNC), etc. In a further aspect, the one or more wireless nodes 104 of system 100 may include one or more small base stations, such as, but not limited to a femtocell, picocell, microcell, or any other small base station. Furthermore, serving wireless node 104 may include a UE parameter altering component 114, which may be configured to receive a binary CQI (e.g. via message 112), process the binary CQI, and potentially alter a serving channel (e.g. serving carrier or serving channel frequency) associated with serving channel 108, UE 102, all UEs 102 served by serving wireless node 104, or a portion thereof.

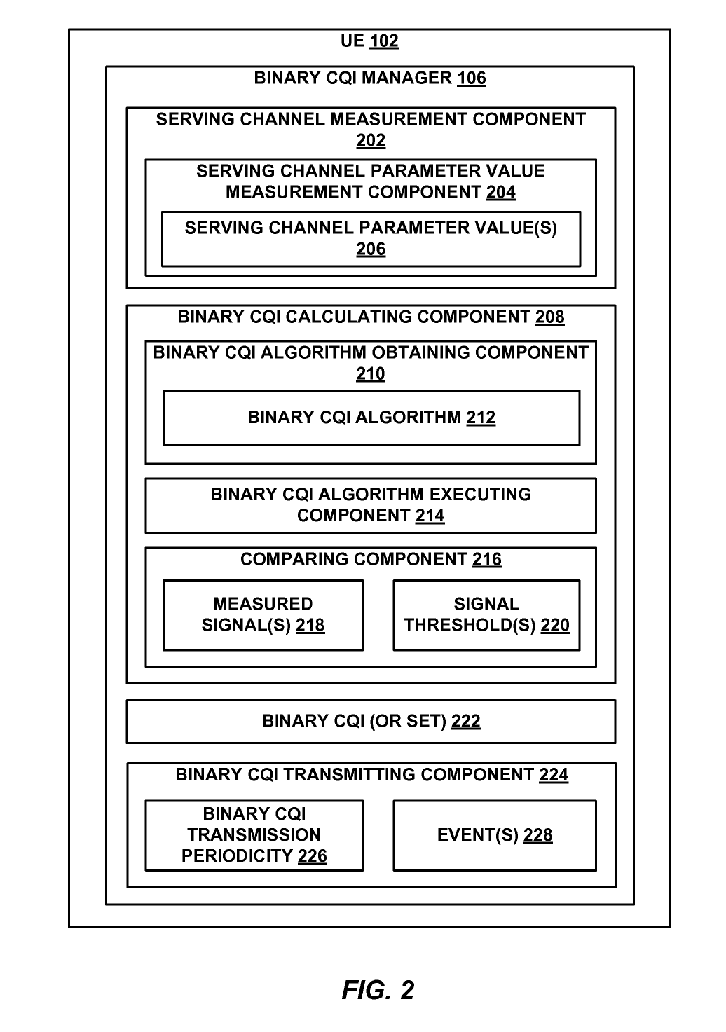

FIG. 2 illustrates an example UE, which may correspond to UE 102 of FIG. 1, which may be configured to compute a binary CQI 222 associated with a serving channel and report the binary CQI 222 to a serving wireless node. In an aspect, as introduced with reference to FIG. 1, UE 102 may include a binary CQI manager 106, which is again illustrated in FIG. 2. In an aspect, binary CQI manager 106 may include a serving channel measurement component 202, which may be configured to measure one or more serving channels associated with the UE 102 and one or more serving wireless nodes (e.g. serving wireless node 104 of FIG. 1). In an aspect, serving channel measurement component 202 may include a serving channel parameter value measurement component 204, which may be configured to measure one or more serving channel parameter values 206 associated with a measured serving channel. As stated above, these one or more serving channel parameter values 206 may be associated with one or more parameters that may include, but are not limited to, a signal-to-noise ratio (e.g., Ec/Io), RSCP, RSSI, and/or any other parameter, such as, but not limited to, those parameters that may indicate channel throughput, quality, and/or reliability. For example, these one or more serving channel parameter values 206 may include parameter values computed based on inherent characteristics of the serving channel, such as, but not limited to, packet error rate (PER), average access delay, packet retransmission rate, Request-to-send, Clear-to-send, and/or Acknowledgement message (RTS/CTS/ACK) error rate, throughput, interference/load statistic, average physical layer data rate, etc. Furthermore, in an aspect, one or more of the serving channel parameter values 206 may be normalized to a percentage based on a particular range of parameter values. Additionally in some aspects, the parameter values 206 can be determined by the UE 102 upon connection setup or reconfigured during connection and may include metric types involved in CQI computation, various thresholds or weights, and/or combinational logic, though these are non-limiting parameter examples. In a further aspect, these parameters (e.g. metric values) may be configured by UE 102.

Additionally, binary CQI manager 106 may include a binary CQI calculating component 208, which may be configured to calculate a binary CQI 222 based, at least in part, on the one or more serving channel parameter values 206. In an aspect, binary CQI calculating component 208 may calculate the binary CQI 222 according to a binary CQI algorithm 212, which in some non-limiting examples may be obtained from a network entity, such as, but not limited to, a serving wireless node. In such examples, the binary CQI calculating component 208 may include a binary CQI algorithm obtaining component 210, which may be configured to obtain the binary CQI algorithm 212 from the serving wireless node. In additional or alternative examples, the binary CQI algorithm 212 may be obtained internally from a memory or other UE component. Furthermore, binary CQI algorithm 212 may include information or instructions as to how the binary CQI 222 should be computed by the binary CQI calculating component 208. In non-limiting examples, the binary CQI algorithm 212 may include instructions as to which of serving channel parameter values 206 should be used in the binary CQI 222 calculation, how much each serving channel parameter value 206 should be weighted in the calculation relative to any other serving channel parameter values, or any other information or instructions related to computing the binary CQI 222. For example, in an aspect, the binary CQI calculating component 208 may perform a summation of weighted serving channel parameter values 206, where the binary CQI algorithm 212 defines the weight to be applied to each value.

In yet a further aspect, binary CQI calculating component 208 may include a binary CQI algorithm executing component 214, which may be configured to execute a binary CQI algorithm 212 to compute a binary CQI or set of binary CQIs 222. In an aspect, binary CQI algorithm executing component 214 may comprise, but is not limited to comprising, a processor, chip, or other integrated circuit configured with logic to execute one or more binary CQI algorithms 212 stored in memory or otherwise presented to the binary CQI algorithm executing component 214.

Furthermore, binary CQI calculating component 208 may include a comparing component 216, which may be configured to calculate a binary CQI 222 by comparing one or more measured signals 218 to one or more corresponding signal thresholds 220. For example, in one non-limiting aspect, the measured signal or signals 218 may be a signal received by serving channel measurement component 202 and may include associated serving channel parameter values 206. Comparing component 216 may compare the measured signal or signals 218 or their associated parameter values to one or more associated signal thresholds 220, which may be preconfigured or dynamic. Based on this comparison, the binary CQI calculating component 208 may determine a binary CQI (or set thereof) 222, which may be an indication of channel quality as simple as “good,” “poor,” or any other binary channel quality identifier. In an additional aspect, binary CQI manager 106 may include a binary CQI transmitting component 224, which may be configured to transmit the binary CQI (or set thereof) 222 to a wireless node, such as a serving wireless node. In an aspect, binary CQI transmitting component 224 may be configured to transmit the binary CQI 222 periodically, such as according to a regular, predetermined schedule, which may be according to a binary CQI transmission periodicity 226. In an aspect, binary CQI transmitting component 224 may be configured for transmitting the one or more serving channel parameter values 206 along with the binary channel quality indicator 222 to the wireless node based on the general quality of the serving channel associated with the binary channel quality indicator 222. In an additional or alternative aspect, binary CQI transmitting component 224 may be configured to transmit the general GQI to the wireless node based on the occurrence of one or more events 228. In an aspect, such an event 228 may include, but is not limited to, an measured signal 218 exceeding (or equaling or dropping below) a signal threshold 220, a wireless node (e.g. a serving wireless node) requesting that the UE 102 report a binary CQI, or a change of status of the binary CQI associated with a serving channel (e.g. a binary CQI changing from “poor” to “good” or vice versa).

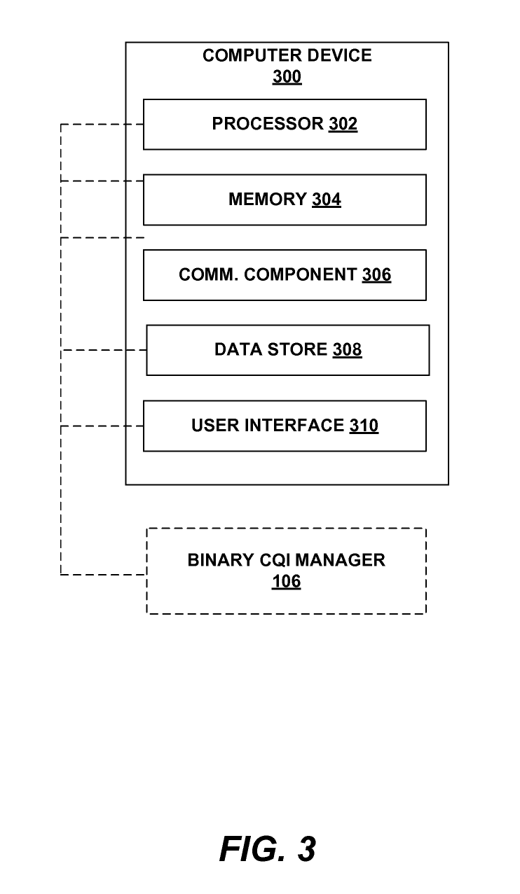

Referring to FIG. 3, in one aspect, UE 102 and/or serving wireless node 104 of FIGS. 1 and/or 2 may be represented by a specially programmed or configured computer device 300. For example, for implementation as UE 102 (FIGS. 1 and 2), computer device 300 may include one or more components for computing and transmitting a binary CQI, such as in specially programmed computer readable instructions or code, firmware, hardware, or some combination thereof. Computer device 300 includes a processor 302 for carrying out processing functions associated with one or more of components and functions described herein. Processor 302 can include a single or multiple set of processors or multi-core processors. Moreover, processor 302 can be implemented as an integrated processing system and/or a distributed processing system.

Computer device 300 further includes a memory 304, such as for storing data used herein and/or local versions of applications being executed by processor 302. Memory 304 can include any type of memory usable by a computer, such as random access memory (RAM), read only memory (ROM), tapes, magnetic discs, optical discs, volatile memory, non-volatile memory, and any combination thereof.

Further, computer device 300 includes a communications component 306 that provides for establishing and maintaining communications with one or more parties utilizing hardware, software, and services as described herein. Communications component 306 may carry communications between components on computer device 300, as well as between computer device 300 and external devices, such as devices located across a communications network and/or devices serially or locally connected to computer device 300. For example, communications component 306 may include one or more buses, and may further include transmit chain components and receive chain components associated with a transmitter and receiver, respectively, or a transceiver, operable for interfacing with external devices. In an additional aspect, communications component 306 may be configured to receive one or more pages from one or more subscriber networks.

Additionally, computer device 300 may further include a data store 308, which can be any suitable combination of hardware and/or software, that provides for mass storage of information, databases, and programs employed in connection with aspects described herein. For example, data store 308 may be a data repository for applications not currently being executed by processor 302 and/or any threshold values or finger position values.

Computer device 300 may additionally include a user interface component 310 operable to receive inputs from a user of computer device 300, and further operable to generate outputs for presentation to the user. User interface component 310 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 310 may include one or more output devices, including but not limited to a display, a speaker, a haptic feedback mechanism, a printer, any other mechanism capable of presenting an output to a user, or any combination thereof. Furthermore, in an optional example, the computer device 300 may include, or may be in communication with, a binary CQI manager 106, which may be configured to perform the functions described in reference to FIGS. 1 and 2 with regard to such a component.

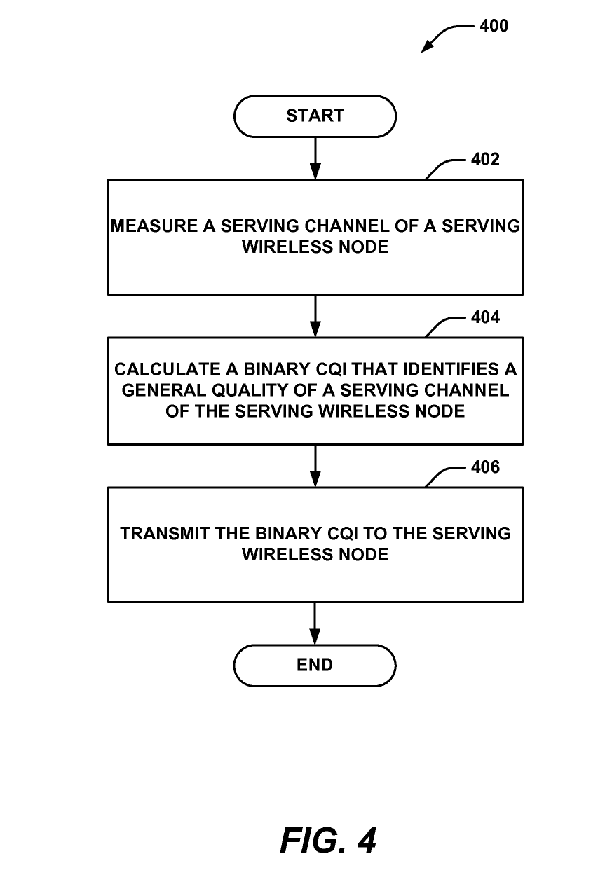

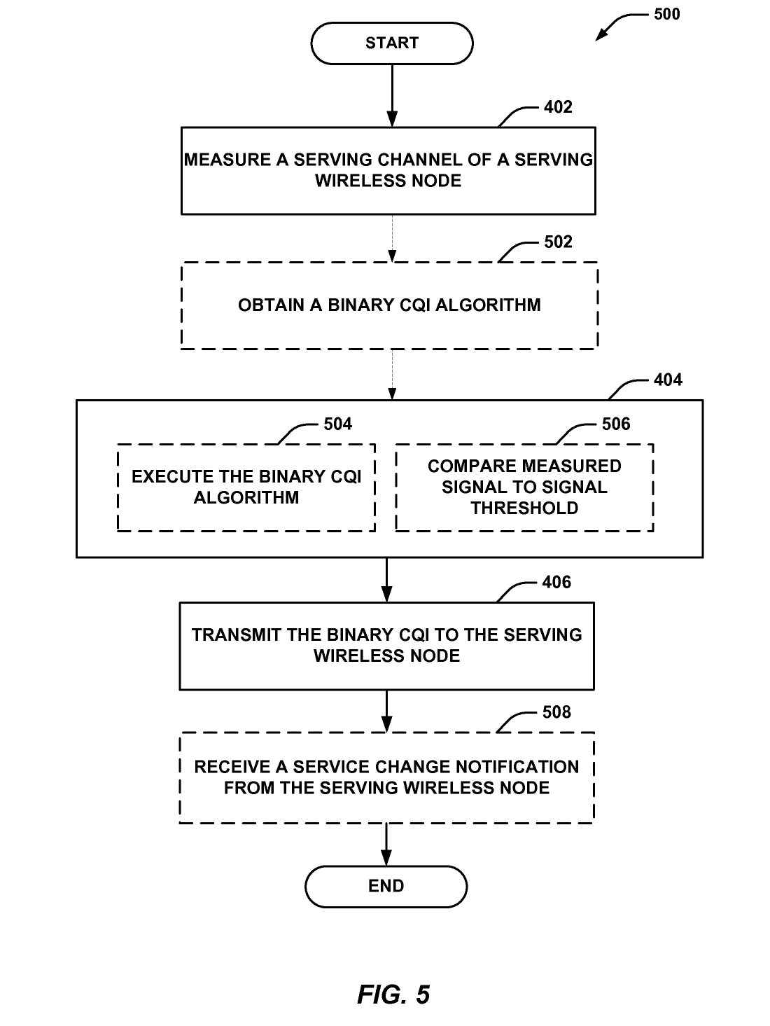

FIGS. 4 and 5 illustrate various methodologies in accordance with various aspects of the presented subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4 illustrates an example methodology 400 for improved and simplified channel quality indication according to aspects of the present disclosure. In an aspect. methodology 400 may be performed by a UE (e.g. UE 102 of FIGS. 1 and 2), and may be performed by a processor or other component capable of executing computer-executable instructions for performing the steps of FIG. 4.

In some examples, methodology 400 may include a UE measuring a serving channel of a wireless node at block 402. In an aspect, the serving channel may include uplink and downlink components. Further, in an aspect, measurements may be performed separately for each component and/or combined for the serving channel. Such measuring may include measuring one or more parameters associated with the serving channel, such as parameters indicative of a channel or communication quality, which may include Ec/Io, RSCP, RSSI, or any other parameter related to the quality of a communication channel. As noted above, the one or more parameter values may include parameter values computed based on inherent characteristics of the serving channel, such as, but not limited to, packet error rate (PER), average access delay, packet retransmission rate, (RTS/CTS/ACK) message error rate, throughput, interference/load statistic, average physical layer data rate, etc. In an aspect, the serving wireless node may indicate to the UE which of the one or more parameters that are included for measurement may be configured by the serving wireless node.

Furthermore, in an aspect, the UE may calculate a binary CQI that identifies a general quality of a serving channel of the wireless node at block 404. In an aspect, a single binary CQU value may be calculated for the serving channel. In another aspect, multiple binary CQI values may be calculated. For example, separate binary CQI values may be calculated for the uplink and downlink components of the serving channel. Further, in an aspect where one or more parameters have been specified by the serving wireless node for measurement, separate binary CQI values may be generated for each of the parameters. In another aspect, the binary CQI calculation may include generation of a poor channel value when at least one of the parameter values exceeds a corresponding threshold. In still another aspect, the binary CQI calculation may include generation of a poor channel value when a weighted sum of normalized values for the one or more serving channel parameter values exceeds a threshold.

In an additional aspect, the UE may transmit the binary CQI to the serving wireless node at block 406. In an aspect, the binary CQI may be transmitted periodically. In another aspect, the binary CQI may be transmitted a frame body or a modified physical/machine access code (PHY/MAC) header of a packet. In still another aspect, the binary CQI may be transmitted in response to the occurrence of an event, such as but not limited to, a received signal strength indication (RSSI) exceeding a threshold value, a measurement indicating a poor channel, reception of a request from the serving wireless node, etc. In yet another aspect, the UE may transmit the binary CQI along with the one or more serving channel parameter values to the wireless node based on the quality of the serving channel associated with the binary channel quality indicator. For example, the UE may always transmit the binary CQI along with the one or more serving channel parameter values to the wireless node. In the alternative, the UE may transmit the binary CQI along with the one or more serving channel parameter values based on the quality of the serving channel associated with the binary CQI, e.g., such as when the serving channel quality is deficient.

FIG. 5 illustrates an example methodology 500, which may be based on and may supplement aspects of methodology 400 of FIG. 4. In an aspect of methodology 500, block 402 of example methodology 400 of FIG. 4 may present—namely, a UE may measure a serving channel of a serving wireless node. Furthermore, in an optional aspect, the UE may obtain a binary CQI algorithm, for example, from a serving wireless node or from internal memory. In an additional aspect of methodology 500, block 404 of methodology 400 of FIG. 4 may be included and may contain one or more optional decision sub-blocks—namely, optional blocks 504 and/or 506. The optional nature of these sub-blocks is indicated in FIG. 5 by the dashed lines constituting the individual blocks and associated flow pointers, which apply likewise to the dashed lines of block 502. For example, at block 504, to calculate the binary CQI, the UE may execute a binary CQI algorithm. In an aspect, such a binary CQI algorithm may be the binary CQI algorithm obtained at block 502 or may be another algorithm. Furthermore, at block 506, the UE may optionally calculate the binary CQI by comparing a measured signal to a signal threshold. In an aspect, the measured signal may be a signal associated, carried by, or received upon, the serving channel measured at block 402. Additionally, the signal threshold or thresholds of block 506 may be preconfigured, static, dynamic, and/or stored in memory. In an aspect, based on the comparison of block 506, the UE may determine that the binary CQI is, for example, “poor,” “good,” “average,” “excellent,” or the like.

In an additional optional aspect, in some examples, the UE may, at block 508, receive a service change notification from a wireless node (e.g., a serving wireless node), which may indicate that the wireless node has determined that one or more characteristics of service will change from those of the current serving channel and may have changed based upon a binary CQI transmitted to the wireless node. For example, the service change notification may include information such as, but not limited to, a time or frame upon which the service change will occur, a channel number or frequency associated with a new serving channel to be used upon the change, and/or a new serving cell or channel to be tuned to upon the change. In an aspect, the notification may prompt the UE to switch to another wireless node and/or another access system based on a determination by the serving wireless node that a comparatively small percent (e.g., less than 20%) of UEs served by the serving wireless node have provided poor channel binary CQI values. In another aspect, the notification may prompt the UE to switch to another channel of the serving wireless node based on a determination by the serving wireless node that a comparatively large percent (e.g., greater than 60%) of UEs served by the serving wireless node have provided poor channel binary CQI values. As such, in some examples, where a “poor” binary CQI has been reported to the serving wireless node, the communication channel may be altered to provide a better user experience to the user of a UE based on the binary CQI with minimal processing and signaling overhead when compared to traditional methods.

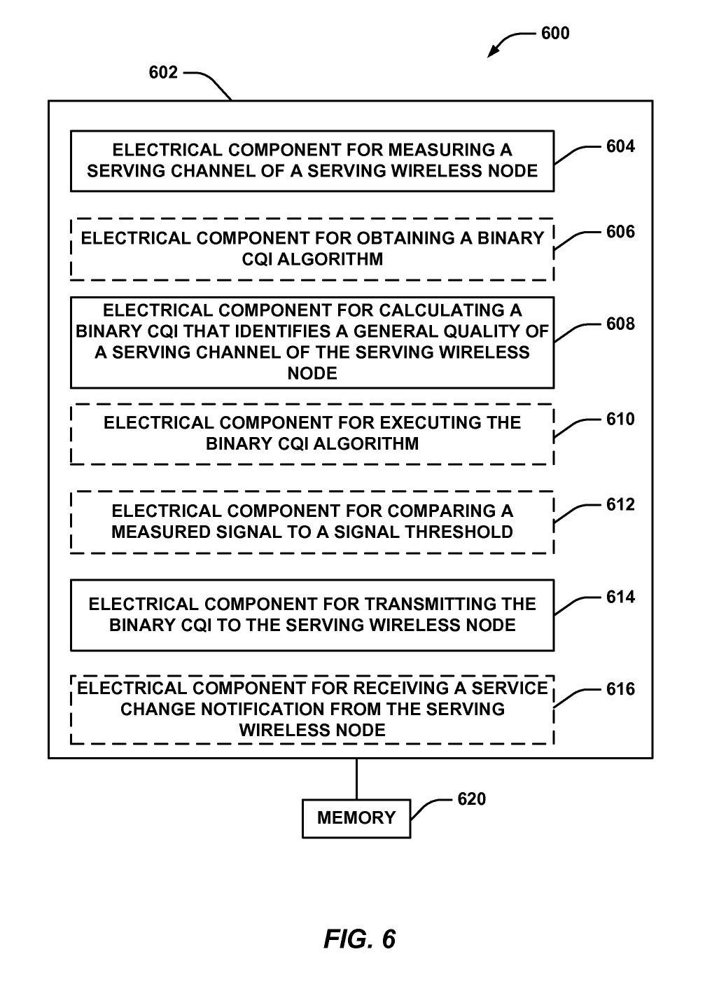

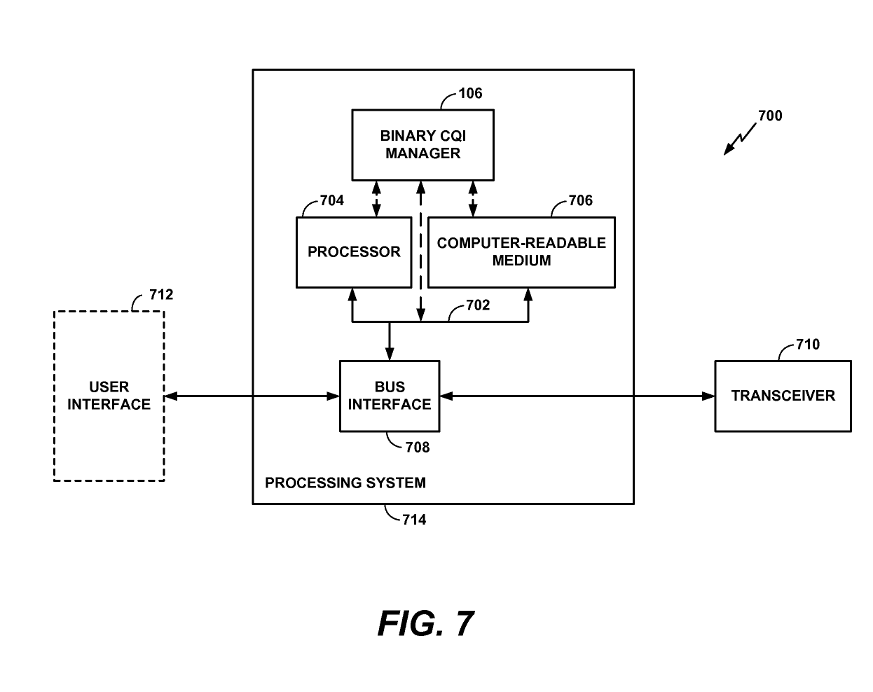

Referring to FIG. 6, an example system 600 is displayed for improved and simplified channel condition feedback to a serving wireless node. For example, system 600 can reside at least partially within UE 102 of FIGS. 1 and 2. It is to be appreciated that system 600 is represented as including functional blocks, which can be functional blocks that represent functions implemented by a processor, software, or combination thereof (e.g., firmware). For example, system 600 may be implemented via processor 302, memory 304 communications component 306 and data store 308 of FIG. 3, by for example, processor 304 executing software stored by data store 308.

Example system 600 includes a logical grouping 602 of electrical components that can act in conjunction. For instance, logical grouping 602 can include an electrical component 604 for measuring a serving channel of a serving wireless node. In an aspect, electrical component 604 may comprise serving channel measurement component 204 (FIG. 2). Additionally, logical grouping 602 can include an optional electrical component 606 for obtaining a binary CQI algorithm. In an aspect, electrical component 606 may comprise binary CQI algorithm obtaining component 210 (FIG. 2). In an aspect, the one or more serving channel parameter values may include a retry rate, a packet error rate (PER), an average access delay, a request to send/clear to send acknowledgement (RTS/CTS/ACK) error rate, a throughput value, a interference/load statistic, an average physical layer data rate, etc. In an additional aspect, logical grouping 602 can include an electrical component 608 for calculating a binary CQI that identifies a general quality of a serving channel of the serving wireless node. In an aspect, electrical component 608 may comprise binary CQI calculating component 208 (FIG. 2). In an aspect, the binary channel quality indicator value may include an uplink binary channel quality indicator value for the uplink component of a serving channel and/or a downlink binary channel quality indicator value for the downlink component of the serving channel. Furthermore, logical grouping 602 can include an optional electrical component 610 for executing the binary CQI algorithm. In an aspect, for example, binary CQI algorithm executing component 214 (FIG. 2) can implement electrical component 610. In such an aspect, electrical component 610 may be configured to generate a poor channel value for the binary channel quality indicator when at least one of the serving channel parameter values exceeds a corresponding threshold. In another aspect, electrical component 610 may be configured to generate a poor channel value for the binary channel quality indicator when a weighted sum of normalized values for the one or more serving channel parameter values exceeds a threshold. Furthermore, logical grouping 602 can include an optional electrical component 612 for comparing a measured signal to a signal threshold. In an aspect, comparing component 216 (FIG. 2) can implement electrical component 612. Furthermore, logical grouping 602 can include an electrical component 614 for transmitting the binary CQI to the serving wireless node. In an aspect, electrical component 614 may comprise binary CQI transmitting component 224 (FIG. 2). In an aspect, the binary CQI may be transmitted periodically. In another aspect, the binary CQI may be transmitted a frame body or a modified physical/machine access code (PHY/MAC) header of a packet. In still another aspect, the binary CQI may be transmitted in response to the occurrence of an event, such as but not limited to, a received signal strength indication (RSSI) exceeding a threshold value, a measurement indicating a poor channel, reception of a request from the serving wireless node, etc. Additionally, logical grouping 602 can include an optional electrical component 616 for receiving a service change notification from the wireless node. In an aspect, electrical component 616 may comprise communications component 306 (FIG. 3). In an aspect, the service change notification may prompt the UE to switch to a non-serving wireless node, another access system, etc. In another aspect, the service change notification may prompt the UE to switch to a channel that is different than the serving channel. Thus, electrical components 604, 606, 608, 610, 612, 614, and 616 may correspond to one or more components in FIGS. 1, 2, and 3, and such components may be separate physical components, components implemented by processor 302, or a combination thereof.

Additionally, system 600 can include a memory 620 that retains instructions for executing functions associated with the electrical components 604, 606, 608, 610, 612, 614, and 616, stores data used or obtained by the electrical components 604, 606, 608, 610, 612, 614, and 616, etc. While shown as being external to memory 620, it is to be understood that one or more of the electrical components 604, 606, 608, 610, 612, 614, and 616 can exist within memory 620. In one example, electrical components 604, 606, 608, 610, 612, 614, and 616 can comprise at least one processor, or each electrical component 604, 606, 608, 610, 612, 614, and 616 can be a corresponding module of at least one processor. Moreover, in an additional or alternative example, electrical components 604, 606, 608, 610, 612, 614, and 616 can be a computer program product including a computer readable medium, where each electrical component 604, 606, 608, 610, 612, 614, and 616 can be corresponding code.

FIG. 7 is a block diagram illustrating an example of a hardware implementation for an apparatus 700 employing a processing system 714 for carrying out improved channel quality feedback, such as for implementing binary CQI manager 106 (FIGS. 1 and 2). In this example, the processing system 714 may be implemented with a bus architecture, represented generally by a bus 702. The bus 702 may include any number of interconnecting buses and bridges depending on the specific application of the processing system 714 and the overall design constraints. The bus 702 links together various circuits including one or more processors, represented generally by the processor 704, computer-readable media, represented generally by the computer-readable storage medium 706, and one or more components described herein, such as, but not limited to, binary CQI manager 106 (FIGS. 1 and 2). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable storage medium 706. The software, when executed by the processor 704, causes the processing system 714 to perform the various functions described infra for any particular apparatus. The computer-readable storage medium 706 may also be used for storing data that is manipulated by the processor 704 when executing software. Thus, binary CQI manager 106 may be a separate physical component, or a component implemented by processor 704 or stored in computer-readable storage medium 706, or a combination thereof.

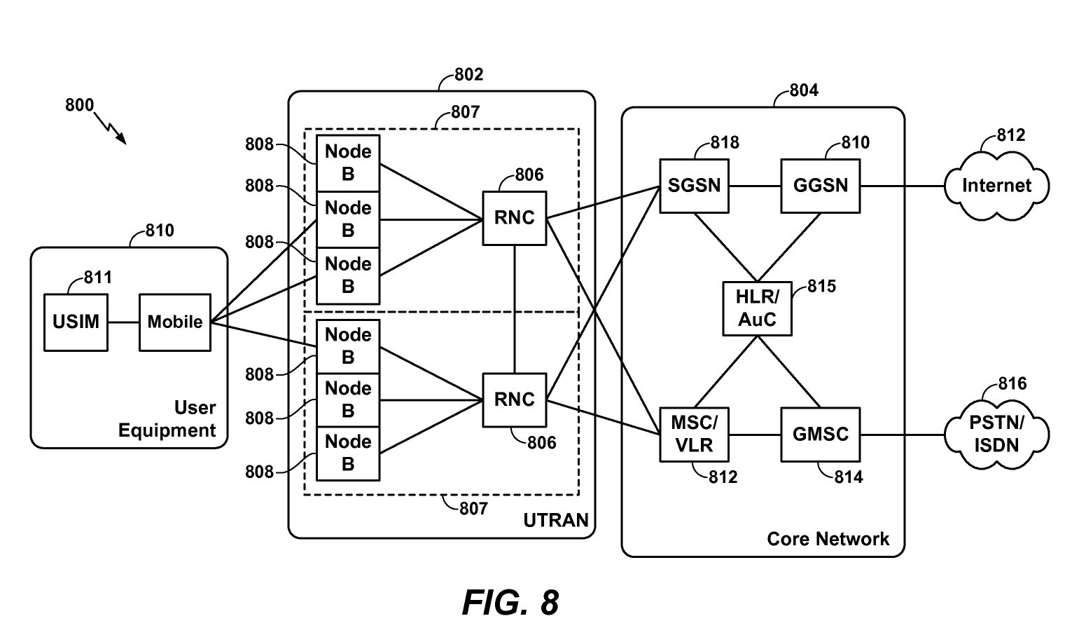

The various concepts presented throughout this disclosure may be implemented across a broad variety of telecommunication systems, network architectures, and communication standards. By way of example and without limitation, the aspects of the present disclosure illustrated in FIG. 8 are presented with reference to a UMTS system 800 employing a WCDMA air interface. A UMTS network includes three interacting domains: a Core Network (CN) 804, a UMTS Terrestrial Radio Access Network (UTRAN) 802, and User Equipment (UE) 810. In an aspect, UE 810 may be UE 102 (FIG. 1) and may be configured to perform simplified serving channel feedback indicators according to the aspects of the present disclosure. In this example, the UTRAN 802 provides various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the RNCs 806 and RNSs 807 illustrated herein. The RNC 806 is an apparatus responsible for, among other things, assigning, reconfiguring, and releasing radio resources within the RNS 807. The RNC 806 may be interconnected to other RNCs (not shown) in the UTRAN 802 through various types of interfaces such as a direct physical connection, a virtual network, or the like, using any suitable transport network.

Communication between a UE 810 and a NodeB 808, which may optionally represent wireless node 104 of FIGS. 1 and 2, may be considered as including a physical (PHY) layer and a medium access control (MAC) layer. Further, communication between a UE 810 and an RNC 806 by way of a respective NodeB 808 may be considered as including a radio resource control (RRC) layer. In the instant specification, the PHY layer may be considered layer 1; the MAC layer may be considered layer 6; and the RRC layer may be considered layer 3. Information herein below utilizes terminology introduced in the RRC Protocol Specification, 3GPP TS 65.331 v9.1.0, incorporated herein by reference.

The geographic region covered by the RNS 807 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 808 are shown in each RNS 807; however, the RNSs 807 may include any number of wireless Node Bs. The Node Bs 808 provide wireless access points to a CN 804 for any number of mobile apparatuses, and may be the wireless node of FIGS. 1-3. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The DL, also called the forward link, refers to the communication link from a NodeB 808 to a UE 810, and the UL, also called the reverse link, refers to the communication link from a UE 810 to a NodeB 808.

The CN 804 interfaces with one or more access networks, such as the UTRAN 802. As shown, the CN 804 is a GSM core network. However, as those skilled in the art will recognize, the various concepts presented throughout this disclosure may be implemented in a RAN, or other suitable access network, to provide UEs with access to types of CNs other than GSM networks.

The CN 804 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 804 supports circuit-switched services with a MSC 812 and a GMSC 814. In some applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a VLR that contains subscriber-related information for the duration that a UE is in the coverage area of the MSC 812. The GMSC 814 provides a gateway through the MSC 812 for the UE to access a circuit-switched network 816. The GMSC 814 includes a home location register (HLR) 815 containing subscriber data, such as the data reflecting the details of the services to which a particular user has subscribed. The HLR is also associated with an authentication center (AuC) that contains subscriber-specific authentication data. When a call is received for a particular UE, the GMSC 814 queries the HLR 815 to determine the UE's location and forwards the call to the particular MSC serving that location.

The CN 804 also supports packet-data services with a serving GPRS support node (SGSN) 818 and a gateway GPRS support node (GGSN) 820. GPRS, which stands for General Packet Radio Service, is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based domain as the MSC 812 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” WCDMA air interface for UMTS is based on such direct sequence spread spectrum technology and additionally calls for a frequency division duplexing (FDD). FDD uses a different carrier frequency for the UL and DL between a NodeB 808 and a UE 810. Another air interface for UMTS that utilizes DS-CDMA, and uses time division duplexing (TDD), is the TD-SCDMA air interface. Those skilled in the art will recognize that although various examples described herein may refer to a WCDMA air interface, the underlying principles may be equally applicable to a TD-SCDMA air interface.

An HSPA air interface includes a series of enhancements to the 3G/WCDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its data channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 810 provides feedback to the node B 808 over the HS-DPCCH to indicate whether it correctly decoded a packet on the downlink.

HS-DPCCH further includes feedback signaling from the UE 810 to assist the node B 808 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 808 and/or the UE 810 may have multiple antennas supporting MIMO technology. The use of MIMO technology enables the node B 808 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 810 to increase the data rate or to multiple UEs 810 to increase the overall system capacity. This is achieved by spatially precoding each data stream and then transmitting each spatially precoded stream through a different transmit antenna on the downlink. The spatially precoded data streams arrive at the UE(s) 810 with different spatial signatures, which enables each of the UE(s) 810 to recover the one or more the data streams destined for that UE 810. On the uplink, each UE 810 may transmit one or more spatially precoded data streams, which enables the node B 808 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

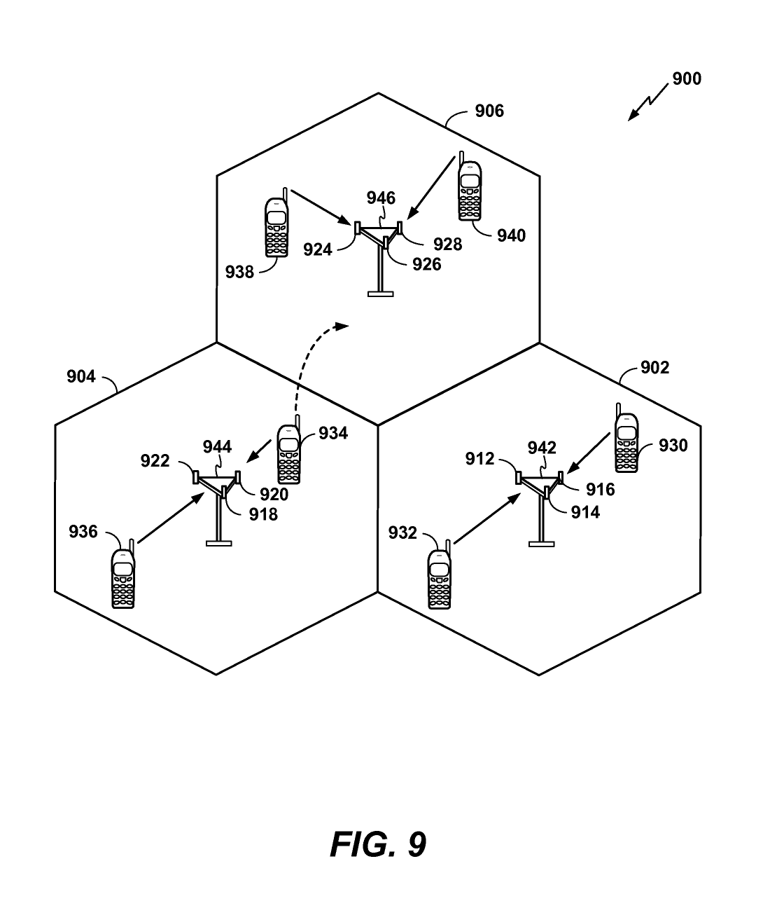

Referring to FIG. 9, an access network 900 in a UTRAN architecture is illustrated. The multiple access wireless communication system includes multiple cellular regions (cells), including cells 902, 904, and 906, each of which may include one or more sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 may include several wireless communication devices, e.g., User Equipment or UEs, which may be in communication with one or more sectors of each cell 902, 904 or 906. For example, UEs 930 and 932 may be in communication with NodeB 942, UEs 934 and 936 may be in communication with NodeB 944, and UEs 938 and 940 can be in communication with NodeB 946. Here, each NodeB 942, 944, 946 is configured to provide an access point to a CN 804 (FIG. 8) for all the UEs 930, 932, 934, 936, 938, 940 in the respective cells 902, 904, and 906. Additionally, each NodeB 942, 944, 946 may represent serving wireless node 104 (FIG. 1) and UEs 930, 932, 934, 936, 938, 940 may represent UE 102 (FIGS. 1 and 2) and may perform the methods outlined herein.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at a radio network controller 806 (FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set).

The modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (WCDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

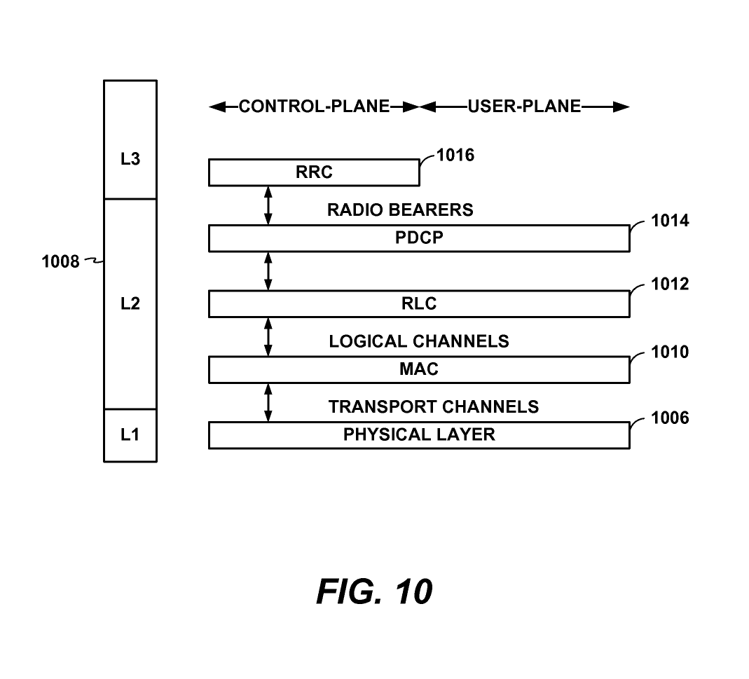

The radio protocol architecture may take on various forms depending on the particular application. An example for an HSPA system will now be presented with reference to FIG. 10, which is a conceptual diagram illustrating an example of the radio protocol architecture for the user and control planes.

Turning to FIG. 10, the radio protocol architecture for the UE and node B is shown with three layers: Layer 1, Layer 2, and Layer 3. Layer 1 is the lowest lower and implements various physical layer signal processing functions. Layer 1 will be referred to herein as the physical layer 1006. Layer 2 (L2 layer) 1008 is above the physical layer 1006 and is responsible for the link between the UE and node B over the physical layer 1006.

In the user plane, the L2 layer 1008 includes a media access control (MAC) sublayer 1010, a radio link control (RLC) sublayer 1012, and a packet data convergence protocol (PDCP) 1014 sublayer, which are terminated at the node B on the network side. Although not shown, the UE may have several upper layers above the L2 layer 1008 including a network layer (e.g., IP layer) that is terminated at a PDN gateway on the network side, and an application layer that is terminated at the other end of the connection (e.g., far end UE, server, etc.).

The PDCP sublayer 1014 provides multiplexing between different radio bearers and logical channels. The PDCP sublayer 1014 also provides header compression for upper layer data packets to reduce radio transmission overhead, security by ciphering the data packets, and handover support for UEs between NodeBs. The RLC sublayer 1012 provides segmentation and reassembly of upper layer data packets, retransmission of lost data packets, and reordering of data packets to compensate for out-of-order reception due to hybrid automatic repeat request (HARQ). The MAC sublayer 1010 provides multiplexing between logical and data channels. The MAC sublayer 1010 is also responsible for allocating the various radio resources (e.g., resource blocks) in one cell among the UEs. The MAC sublayer 1010 is also responsible for HARQ operations.

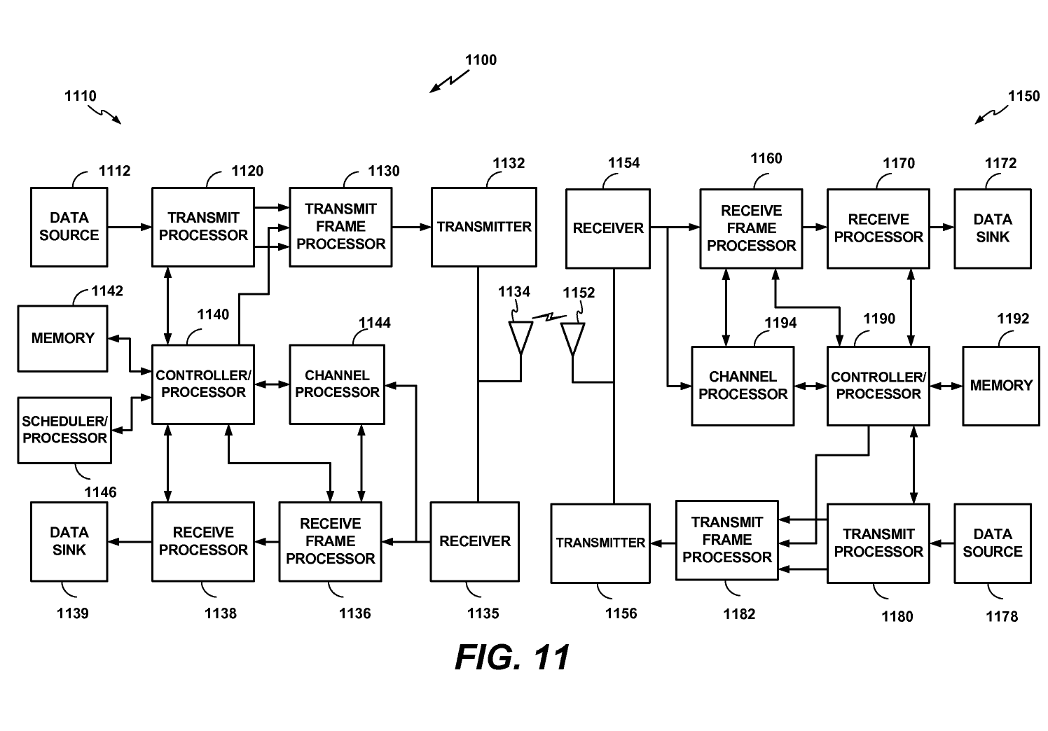

FIG. 11 is a block diagram of a NodeB 1110 in communication with a UE 1150, where the NodeB 1110 may be the NodeB 808 in FIG. 8 and/or serving wireless node 104 (FIG. 1), and the UE 1050 may be UE 102 of FIGS. 1 and/or 2. In the downlink communication, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided to a transmit frame processor 1130 to create a frame structure. The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the NodeB 1110. More specifically, the receive processor 1170 descrambles and despreads the symbols, and then determines the most likely signal constellation points transmitted by the NodeB 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the NodeB 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the NodeB 1110 or from feedback contained in the midamble transmitted by the NodeB 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the NodeB 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing performed by the transmit processor 1180 in the UE 1150. The data and control signals carried by the successfully decoded frames may then be provided to a data sink 1139 and the controller/processor, respectively. If some of the frames were unsuccessfully decoded by the receive processor, the controller/processor 1140 may also use an acknowledgement (ACK) and/or negative acknowledgement (NACK) protocol to support retransmission requests for those frames.

The controller/processors 1140 and 1190 may be used to direct the operation at the NodeB 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the NodeB 1110 and the UE 1150, respectively. A scheduler/processor 1146 at the NodeB 1110 may be used to allocate resources to the UEs and schedule downlink and/or uplink transmissions for the UEs.

Several aspects of a telecommunications system have been presented with reference to a WCDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium. The computer-readable storage medium may be a non-transitory computer-readable storage medium. A non-transitory computer-readable storage medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable storage medium may also include, by way of example, a carrier wave, a transmission line, and any other suitable medium for transmitting software and/or instructions that may be accessed and read by a computer. The computer-readable storage medium may be resident in the processing system, external to the processing system, or distributed across multiple entities including the processing system. The computer-readable storage medium may be embodied in a computer-program product. By way of example, a computer-program product may include a computer-readable storage medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication by a user equipment (UE), comprising:
measuring a serving channel of a serving wireless node, wherein the serving channel includes an uplink component and a downlink component;
calculating a binary channel quality indicator that identifies a general quality of the serving channel; and
transmitting the binary channel quality indicator to the serving wireless node.

2. The method of claim 1, further comprising:
obtaining, from the serving wireless node, a binary channel quality indicator algorithm that defines how to calculate the binary channel quality indicator;
wherein measuring the serving channel further comprises measuring one or more serving channel parameter values defined with the binary channel quality indicator algorithm; and
wherein calculating the binary channel quality indicator further comprises executing the binary channel quality indicator algorithm with at least the one or more serving channel parameter values.

3. The method of claim 2, wherein the one or more serving channel parameter values comprise at least one of: a retry rate, a packet error rate (PER), an average access delay, a request to send and a request to clear to send acknowledgement (RTS/CTS/ACK) error rate, a throughput value, interference and load statistics, or an average physical layer data rate.

4. The method of claim 2, wherein the calculating further comprises generating a poor channel value for the binary channel quality indicator when either:
at least one of the one or more serving channel parameter values exceeds a corresponding threshold, or
a weighted sum of normalized values for the one or more serving channel parameter values exceeds a threshold.

5. The method of claim 2, further comprising:
transmitting the one or more serving channel parameter values along with the binary channel quality indicator to the serving wireless node based on the general quality of the serving channel associated with the binary channel quality indicator.

6. The method of claim 1, wherein calculating the binary channel quality indicator further comprises calculating a single binary channel quality indicator value or a set of binary channel quality indicator values.

7. The method of claim 6, wherein the set of binary channel quality indicator values comprises at least one of: an uplink binary channel quality indicator value for the uplink component, or a downlink binary channel quality indicator value for the downlink component.

8. The method of claim 1, further comprising receiving a service change notification in response to the transmitting the binary channel quality indicator, wherein the service change notification is issued by the serving wireless node.

9. The method of claim 8, wherein the service change notification prompts the UE to:
switch to at least one of a non-serving wireless node, or an access system; or.
switch to a second channel that is different than the serving channel.

10. The method of claim 1, wherein transmitting the binary channel quality indicator comprises transmitting the binary channel quality indicator periodically.

11. The method of claim 1, wherein the binary channel quality indicator is transmitted using at least one of a frame body or a modified physical/machine access code (PHY/MAC) header of a packet.

12. The method of claim 1, wherein transmitting the binary channel quality indicator comprises transmitting the binary channel quality indicator upon an occurrence of an event.

13. The method of claim 12, wherein the event comprises at least one of:
a received signal strength indication (RSSI) measurement exceeding a threshold value,
a parameter measurement indicating a poor channel, or
reception of a request to report from the serving wireless node.

14. An apparatus for wireless communication, comprising:
means for measuring a serving channel of a serving wireless node, wherein the serving channel includes an uplink component and a downlink component;
means for calculating a binary channel quality indicator that identifies a general quality of the serving channel; and
means for transmitting the binary channel quality indicator to the serving wireless node.

15. The apparatus of claim 14, further comprising:
means for obtaining, from the serving wireless node, a binary channel quality indicator algorithm that defines how to calculate the binary channel quality indicator;
wherein means for measuring the serving channel further is further configured to measure one or more serving channel parameter values defined with the binary channel quality indicator algorithm; and
wherein means for calculating the binary channel quality indicator is further configured to execute the binary channel quality indicator algorithm with at least the one or more serving channel parameter values.

16. The apparatus of claim 15, wherein the one or more serving channel parameter values comprise at least one of: a retry rate, a packet error rate (PER), an average access delay, a request to send and a request to clear to send acknowledgement (RTS/CTS/ACK) error rate, a throughput value, interference and load statistics, or an average physical layer data rate.

17. The apparatus of claim 15, wherein the means for calculating is further configured to generate a poor channel value for the binary channel quality indicator when either:
at least one of the one or more serving channel parameter values exceeds a corresponding threshold, or
a weighted sum of normalized values for the one or more serving channel parameter values exceeds a threshold.

18. The apparatus of claim 15, further comprising:
means for transmitting the one or more serving channel parameter values along with the binary channel quality indicator to the serving wireless node based on the general quality of the serving channel associated with the binary channel quality indicator.

19. The apparatus of claim 14, wherein the means for calculating the binary channel quality indicator is further configured to calculate a single binary channel quality indicator value or a set of binary channel quality indicator values.

20. The apparatus of claim 19, wherein the set of binary channel quality indicator values comprises at least one of: an uplink binary channel quality indicator value for the uplink component, or a downlink binary channel quality indicator value for the downlink component.

21. The apparatus of claim 14, further comprising means for receiving a service change notification in response to the transmitting the binary channel quality indicator, wherein the service change notification is issued by the serving wireless node.

22. The apparatus of claim 21, wherein the service change notification prompts the UE to:
switch to at least one of a non-serving wireless node, or an access system; or.
switch to a second channel that is different than the serving channel.

23. The apparatus of claim 14, wherein the means for transmitting the binary channel quality indicator is configured to transmit the binary channel quality indicator periodically.

24. The apparatus of claim 14, wherein the means for transmitting the binary channel quality indicator is configured to transmit the binary channel quality indicator using at least one of a frame body or a modified physical/machine access code (PHY/MAC) header of a packet.

25. The apparatus of claim 14, wherein the means for transmitting the binary channel quality indicator is configured to transmit the binary channel quality indicator upon an occurrence of an event.

26. The apparatus of claim 25, wherein the event comprises at least one of:
a received signal strength indication (RSSI) measurement exceeding a threshold value,
a parameter measurement indicating a poor channel, or
reception of a request to report from the serving wireless node.

27. A computer-readable medium comprising machine-executable code for:
measuring a serving channel of a serving wireless node, wherein the serving channel includes an uplink component and a downlink component;
calculating a binary channel quality indicator that identifies a general quality of the serving channel; and
transmitting the binary channel quality indicator to the serving wireless node.

28. The computer-readable medium of claim 27, further comprising machine-executable code for:
obtaining, from the serving wireless node, a binary channel quality indicator algorithm that defines how to calculate the binary channel quality indicator;
wherein measuring the serving channel further comprises measuring one or more serving channel parameter values defined with the binary channel quality indicator algorithm; and
wherein calculating the binary channel quality indicator further comprises executing the binary channel quality indicator algorithm with at least the one or more serving channel parameter values.

29. The computer-readable medium of claim 28, wherein the one or more serving channel parameter values comprise at least one of: a retry rate, a packet error rate (PER), an average access delay, a request to send and a request to clear to send acknowledgement (RTS/CTS/ACK) error rate, a throughput value, interference and load statistics, or an average physical layer data rate.

30. The computer-readable medium of claim 28, further comprising machine-executable code for generating a poor channel value for the binary channel quality indicator when either:
at least one of the one or more serving channel parameter values exceeds a corresponding threshold, or
a weighted sum of normalized values for the one or more serving channel parameter values exceeds a threshold.

31. The computer-readable medium of claim 28, further comprising machine-executable code for:
transmitting the one or more serving channel parameter values along with the binary channel quality indicator to the serving wireless node based on the general quality of the serving channel associated with the binary channel quality indicator.

32. The computer-readable medium of claim 27, further comprising machine-executable code for calculating a single binary channel quality indicator value or a set of binary channel quality indicator values.

33. The computer-readable medium of claim 32, wherein the set of binary channel quality indicator values comprises at least one of: an uplink binary channel quality indicator value for the uplink component, or a downlink binary channel quality indicator value for the downlink component.

34. The computer-readable medium of claim 27, further comprising machine-executable code for receiving a service change notification in response to the transmitting the binary channel quality indicator, wherein the service change notification is issued by the serving wireless node.

35. The computer-readable medium of claim 34, wherein the service change notification prompts the UE to:
switch to at least one of a non-serving wireless node, or an access system; or.
switch to a second channel that is different than the serving channel.

36. The computer-readable medium of claim 27, further comprising machine-executable code for transmitting the binary channel quality indicator periodically.

37. The computer-readable medium of claim 27, wherein the binary channel quality indicator is transmitted using at least one of a frame body or a modified physical/machine access code (PHY/MAC) header of a packet.

38. The computer-readable medium of claim 27, further comprising machine-executable code for transmitting the binary channel quality indicator upon an occurrence of an event.

39. The method of claim 38, wherein the event comprises at least one of:
a received signal strength indication (RSSI) measurement exceeding a threshold value,
a parameter measurement indicating a poor channel, or
reception of a request to report from the serving wireless node.

40. An apparatus for wireless communication, comprising:
at least one processor; and
a memory coupled to the at least one processor, wherein the at least one processor is configured to:
measure a serving channel of a serving wireless node, wherein the serving channel includes an uplink component and a downlink component;
calculate a binary channel quality indicator that identifies a general quality of the serving channel; and
transmit the binary channel quality indicator to the serving wireless node.

41. The apparatus of claim 40, wherein the at least one processor is further configured to:
obtain, from the serving wireless node, a binary channel quality indicator algorithm that defines how to calculate the binary channel quality indicator;
measure one or more serving channel parameter values defined with the binary channel quality indicator algorithm; and
execute the binary channel quality indicator algorithm with at least the one or more serving channel parameter values.

42. The apparatus of claim 41, wherein the one or more serving channel parameter values comprise at least one of: a retry rate, a packet error rate (PER), an average access delay, a request to send and a request to clear to send acknowledgement (RTS/CTS/ACK) error rate, a throughput value, interference and load statistics, or an average physical layer data rate.

43. The apparatus of claim 41, wherein the at least one processor is further configured to generate a poor channel value for the binary channel quality indicator when either:
at least one of the one or more serving channel parameter values exceeds a corresponding threshold, or
a weighted sum of normalized values for the one or more serving channel parameter values exceeds a threshold.

44. The apparatus of claim 41, wherein the at least one processor is further configured to:
transmit the one or more serving channel parameter values along with the binary channel quality indicator to the serving wireless node based on the general quality of the serving channel associated with the binary channel quality indicator.

45. The apparatus of claim 40, wherein the at least one processor is further configured to calculate a single binary channel quality indicator value or a set of binary channel quality indicator values.

46. The apparatus of claim 45, wherein the set of binary channel quality indicator values comprises at least one of: an uplink binary channel quality indicator value for the uplink component, or a downlink binary channel quality indicator value for the downlink component.

47. The apparatus of claim 40, wherein the at least one processor is further configured to receive a service change notification in response to the transmitting the binary channel quality indicator, wherein the service change notification is issued by the serving wireless node.

48. The apparatus of claim 47, wherein the service change notification prompts the UE to:
switch to at least one of a non-serving wireless node, or an access system; or.
switch to a second channel that is different than the serving channel.

49. The apparatus of claim 40, wherein the at least one processor is further configured to transmit the binary channel quality indicator periodically.

50. The apparatus of claim 40, wherein the binary channel quality indicator is transmitted using at least one of a frame body or a modified physical/machine access code (PHY/MAC) header of a packet.

51. The apparatus of claim 40, wherein the at least one processor is further configured to transmit the binary channel quality indicator upon an occurrence of an event.

52. The apparatus of claim 51, wherein the event comprises at least one of:
a received signal strength indication (RSSI) measurement exceeding a threshold value,
a parameter measurement indicating a poor channel, or
reception of a request to report from the serving wireless node.
